(19) United States
(12) Patent Application Publication
(10) Pub. No.: US 2006/0175382 A1
(43) Pub. Date: Aug. 10, 2006

(54) Tool geometries for friction stir spot welding of high melting temperature alloys

(76) Inventors: Scott M. Packer, Alpine, UT (US); Russell J. Steel, Salem, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/355,514

(22) Filed: Feb. 15, 2006

Related U.S. Application Data
(63) Continuation-in-part of application No. 10/705,668, filed on Nov. 10, 2003.
(63) Continuation-in-part of application No. 10/705,717, filed on Nov. 10, 2003.
(60) Provisional application No. 60/653,158, filed on Feb. 15, 2005.

(51) Int. Cl. B23K 20/12

(52) U.S. Cl. 228/112.1; 228/2.1

(57) ABSTRACT

A tool for friction stir spot welding of high melting temperature materials, wherein the tool geometry includes a short pin and broad shoulder to enhance mixing of high temperature materials, and wherein the tool includes a superabrasive coating to thereby enable FSSW of high melting temperature materials.

### CROSS REFERENCE TO RELATED APPLICATIONS

This document claims priority to and incorporates by reference all of the subject matter included in the provisional patent application having docket number 3252.SMII.PR, with Ser. No. 60/653,158 and filed on Feb. 15, 2005, and the subject matter in Continuation patent applications having docket number 1219.BYU.CN with Ser. No. 10/705,668 and filed on Nov. 10, 2003, and docket number 1219.BYU.CN2 with Ser. No. 10/705,717 and filed on Nov. 10, 2003.

### BACKGROUND OF THE INVENTION

1. Field Of the Invention

This invention relates generally to friction stir welding. More specifically, the present invention relates to spot welding of high melting temperature alloys.

2. Description of Related Art

There are many applications in a variety of industries that require spot welding. For example, the shipyard, marine, automotive, transportation, aerospace, nuclear, oil and gas and other industries all need to join together, generally using a lap configuration, high melting temperature alloys which include, among others, steel, stainless steel, nickel base, and other alloys. One of the most common methods used to perform spot welding is known in the industry as resistance spot welding (RSW). RSW passes electric current through the materials being joined to thereby form a molten pool of metal at the desired joint location. When the molten pool cools and solidifies, a spot weld joint is formed.

There are many drawbacks to RSW technology. These drawbacks include high energy costs, brittle joints that lead to cracking at the location of the weld, hazardous fumes that are emitted, low joint strength, susceptibility to corrosion, solidification defects, lack of repeatability due to probe wear at the electrode joint, and the difficulty of inspecting the quality of the joint.

One of the more prominent applications for resistive spot welding is joining together the pieces of a frame for the body of cars and trucks. However, the automotive industry continues to struggle with RSW to reliably manufacture cars.

Of particular importance to the US government is the crash worthiness of a car or truck body. Accordingly, the US government requires that cars produced for the consumer undergo destructive testing to determine RSW quality. For example, a car body of each car model produced is randomly selected from that production line by a Department of Transportation inspector after it has been spot welded. Welds are selected to be broken, and this action is performed with a hand-held tool similar to a screw driver. Generally, one car body from each line is destructively tested each month from each manufacturer. However, manufacturers typically do significant destructive testing on their own by performing the test on a vehicle as often as each shift to make sure vehicle crashworthiness is maintained.

This destructive inspection process is typically used because of the unreliable nature of RSW. Some manufacturers are also careful to make sure that more than one soldering machine or robot makes the welds on any single vehicle. In this way, if a robot is creating underperforming welds, the risk is decreased to any particular vehicle.

The automotive industry is also pursuing the use of Advanced High Strength Steels (AHSS) in order to lighten vehicles and improve fuel economy. Some of these steels are far more difficult to RSW. Some of the steels cannot be welded at all using RSW. Furthermore, the AHSS pose far more process control issues than existing steels made in today's vehicles. For example, one process control issue is load. It is necessary to pinch the materials that are to be resistance spot welded. Another issue is that of the gap between the parts to be welded. The parts need to be flush, or the strength of the weld may be compromised. Another issue is the amount of electricity needed to perform RSW on AHSS.

Although a substantial weight savings can be obtained if these advanced steels can be used in vehicle construction, there has been very little success because of the joining problems associated with RSW.

It is noted that one automobile manufacturer has used friction stir spot welding (FSSW) on aluminum door panels. However, because of existing FSSW tool limitations, aluminum (a low melting temperature alloy) has been the only material that can be joined by the RSW process. Unfortunately, aluminum cannot be used for structural components in a vehicle such as for the frame or body, and therefore its use is limited not only in automotive applications, but for other applications as well.

Accordingly, what is needed is a tool and method of performing friction stir spot welding (FSSW) that can be used on AHSS to thereby enable use of high melting temperature alloys in a vehicle frame or body.

It is useful for the understanding of the present invention to know that friction stir welding is a technology that has been developed for welding metals and metal alloys. The FSW process often involves engaging the material of two adjoining workpieces on either side of a joint by a rotating stir pin or spindle. Force is exerted to urge the spindle and the workpieces together and frictional heating caused by the interaction between the spindle and the workpieces results in plasticization of the material on either side of the joint. The spindle is traversed along the joint, plasticizing material as it advances, and the plasticized material left in the wake of the advancing spindle cools to form a weld.

FIG. 1 is a perspective view of a tool being used for friction stir welding that is characterized by a generally cylindrical tool 10 having a shoulder 12 and a pin 14 extending outward from the shoulder. The pin 14 is rotated against a workpiece 16 until sufficient heat is generated, at which point the pin of the tool is plunged into the plasticized workpiece material. The workpiece 16 is often two sheets or plates of material that are butted together at a joint line 18. The pin 14 is plunged into the workpiece 16 at the joint line 18. Although this tool has been disclosed in the prior art, it will be explained that the tool can be used for a new purpose. It is also noted that the terms “workpiece” and “base material” will be used interchangeably throughout this document.

The frictional heat caused by rotational motion of the pin 14 against the workpiece material 16 causes the workpiece material to soften without reaching a melting point. The tool 10 is moved transversely along the joint line 18, thereby creating a weld as the plasticized material flows around the pin from a leading edge to a trailing edge. The result is a solid phase bond 20 at the joint line 18 that may be generally indistinguishable from the workpiece material 16 itself, in comparison to other welds.

It is observed that when the shoulder 12 contacts the surface of the workpieces, its rotation creates additional frictional heat that plasticizes a larger cylindrical column of material around the inserted pin 14. The shoulder 12 provides a forging force that contains the upward metal flow caused by the tool pin 14.

During FSW, the area to be welded and the tool are moved relative to each other such that the tool traverses a desired length of the weld joint. The rotating FSW tool provides a continual hot working action, plasticizing metal within a narrow zone as it moves transversely along the base metal, while transporting metal from the leading face of the pin to its trailing edge. As the weld zone cools, there is typically no solidification as no liquid is created as the tool passes. It is often the case, but not always, that the resulting weld is a defect-free, re-crystallized, fine grain microstructure formed in the area of the weld.

Travel speeds are typically 10 to 500 mm/min with rotation rates of 200 to 2000 rpm. Temperatures reached are usually close to, but below, solidus temperatures. Friction stir welding parameters are a function of a material's thermal properties, high temperature flow stress and penetration depth.

Previous patents by some of the inventors such as U.S. Pat. Nos. 6,648,206 and 6,779,704 have taught the benefits of being able to perform friction stir welding with materials that were previously considered to be functionally unweldable. Some of these materials are non-fusion weldable, or just difficult to weld at all. These materials include, for example, metal matrix composites, ferrous alloys such as steel and stainless steel, and non-ferrous materials. Another class of materials that were also able to take advantage of friction stir welding is the superalloys. Superalloys can be materials having a higher melting temperature bronze or aluminum, and may have other elements mixed in as well. Some examples of superalloys are nickel, iron-nickel, and cobalt-based alloys generally used at temperatures above 1000 degrees F. Additional elements commonly found in superalloys include, but are not limited to, chromium, molybdenum, tungsten, aluminum, titanium, niobium, tantalum, and rhenium.

It is noted that titanium is also a desirable material to friction stir weld. Titanium is a non-ferrous material, but has a higher melting point than other nonferrous materials.

The previous patents teach that a tool is needed that is formed using a material that has a higher melting temperature than the material being friction stir welded. In some embodiments, a superabrasive was used in the tool.

The embodiments of the present invention are generally concerned with these functionally unweldable materials, as well as the superalloys, and are hereinafter referred to as “high melting temperature” materials throughout this document.

While the examples above have addressed friction stir welding, friction stir processing and friction stir mixing are also aspects of the invention that must be considered. It is noted that friction stir processing and welding may be exclusive events of each other, or they may take place simultaneously. It is also noted that the phrase “friction stir processing” may also be referred to interchangeably with solid state processing. Solid state processing is defined herein as a temporary transformation into a plasticized state that typically does not include a liquid phase. However, it is noted that some embodiments allow one or more elements to pass through a liquid phase, and still obtain the benefits of the present invention.

In friction stir processing, a tool pin is rotated and plunged into the material to be processed. The tool is moved transversely across a processing area of the material. It is the act of causing the material to undergo plasticization in a solid state process that can result in the material being modified to have properties that are different from the original material.

Friction stir mixing can also be an event that is exclusive of welding, or it can take place simultaneously. In friction stir mixing, at least one other material is being added to the material being processed or welded.

MegaStir Technologies (a business alliance between Advanced Metal Products, Inc. and SII MegaDiamond, Inc.) has developed friction stir welding (FSW) tools that can be used to join high melting temperature materials such as steel and stainless steel together during the solid state joining processes termed FSW. This technology generally involves using a polycrystalline cubic boron nitride tip 30 (including pin and shoulder areas), insulation behind the tip (not shown), a locking collar 32, a set screw 34 and a shank 36 as shown in FIG. 2.

When this tool is used with the proper friction stir welding machine and proper steady state cooling, it is effective at friction stir welding of various materials. This tool design is also effective for using a variety of tool tip materials besides PCBN. Some of these materials include refractories such as tungsten, rhenium, iridium, titanium, etc.

Since these tip materials are often expensive to produce this design is an economical way of producing and providing tools to the market place. The design shown in FIG. 2 is in part driven by the limited sizes that can be produced by sintering, hipping, and other high pressure equipment capabilities.

### BRIEF SUMMARY OF THE INVENTION

It is an aspect of the present invention to provide a tool geometry that enables FSSW of high melting temperature materials.

It is another aspect to provide a tool for performing FSSW that includes materials that enable FSSW of high melting temperature materials.

In a preferred embodiment, the present invention is a tool for friction stir spot welding of high melting temperature materials, wherein the tool geometry includes a short pin and broad shoulder to enhance mixing of high temperature materials, and wherein the tool includes a superabrasive coating to thereby enable FSSW of high melting temperature materials.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a prior art perspective view of an existing friction stir welding tool capable of performing FSW on high melting temperature materials

FIG. 2 is another prior art perspective view of an existing friction stir welding tool capable of performing FSW on high melting temperature materials.

FIG. 3A is an illustration of one embodiment of a tool that can perform the desired friction stir spot welding of the present invention. FIG. 3A is a profile view of a tool holder and a PCBN tip disposed therein.

FIG. 3B is a first profile view of the PCBN tip.

FIG. 3C is a second profile view of the PCBN tip.

FIG. 4A is an illustration of another embodiment of a tool that can perform the desired friction stir spot welding of the present invention. FIG. 4A is a profile view of a tool holder and a PCBN pin disposed therein.

FIG. 4B is a first profile view of the PCBN pin with view F circled.

FIG. 4C is a close-up profile view of the threaded PCBN pin of view F.

FIG. 4D is an end-view of the PCBN pin and toolholder.

FIG. 5 is an illustration of two FSSW spot welds wherein parameters have been modified to obtain different spot welds.

FIG. 6 is an illustration of three friction stir spot welds.

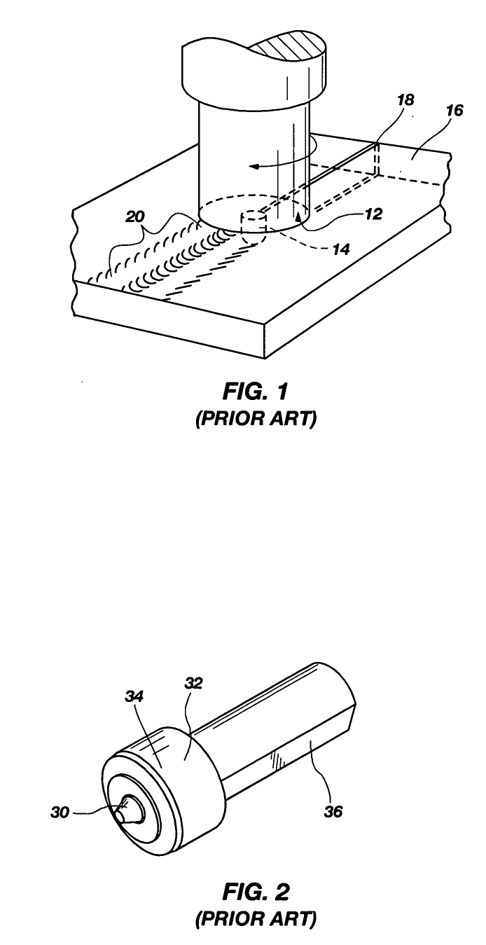

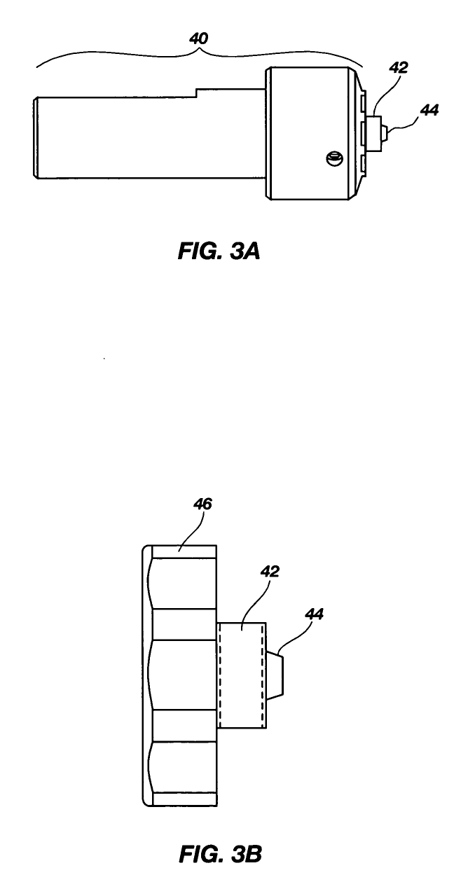

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

From recent developments with tool materials such as Polycrystalline Cubic Boron Nitride (PCBN) and other materials which have a higher melting point than those materials being joined, friction stir welding (FSW) of high melting temperature materials has become a reality. However, in recent FSSW tests, it has become apparent that the tool geometries used for FSSW are going to be different from those used in FSW. Changes in tool geometry include, but should not be considered limited to, pin length, modifying the pin length to shoulder width ratio, the pin geometries, shoulder geometries, the use of the shoulder without the pin, the use of the pin only, the use of threads on the pin, and the height of the pin.

Many of the tool geometries used for FSW need a relatively long pin on the tool in order to join thicker workpieces together when making a butt joint. In contrast, FSSW is generally going to be performed on relatively thinner workpieces. Thus, the pin may generally be shorter than on a tool used for FSW. This shorter pin can be used even if the tool is going to penetrate both materials that are being FSSW together.

Along with pin length, another aspect of the present invention is an understanding that the pin length to shoulder width ratio is important to FSSW because of friction stir mixing and welding. It is desirable to have a broad area of the workpieces being mixed together. FSSW of a broader area is more easily accomplished having a shoulder that is relatively broad.

In the present invention, a FSSW joint is achieved using a generally solid state process with minimal or no melting of the materials being joined. Therefore, it is important that the tool geometry enables the material of the workpieces to be processed in such a way that the materials mechanically bond.

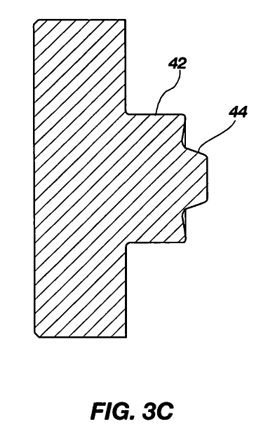

For example, when a tool having the geometry of the tool shown in FIGS. 3A to 3D is rotated at 1500 RPM, plunges into a lap joint of AHSS at a plunge rate of 2 to 8 inches per minute, dwells for 1 to 10 seconds, and is retracted, a FSSW joint with a mechanical bond is created. It should be understood that these parameters are for illustration purposes only, and may be varied to achieve the same or similar results.

FIG. 3A is provided as a profile view of a FSSW toolholder 40 and a FSSW tip comprised of a shoulder 42 and a pin 44.

FIG. 3B is a profile view of the PCBN tip wherein the shoulder 42 and pin 44 are coupled to a short shank 46.

FIG. 3C is a close-up profile view of the PCBN tip where detail of the shoulder 42 and the pin is more plainly visible.

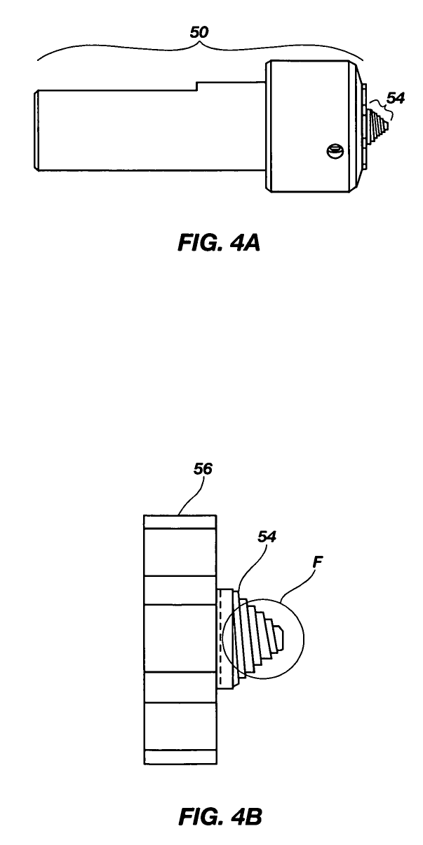

FIG. 4A is provided as a profile view of a FSSW toolholder 50 and a FSSW tip comprised of a pin 54 without any shoulder.

FIG. 4B is a profile view of the PCBN tip wherein the pin 54 is coupled to a short shank 56.

FIG. 4C is a close-up profile view of the PCBN tip showing the stepped spiral threads 58 of the pin 54. The stepped spiral threads 58 are created using two threaded starts in this particular embodiment. This particular configuration of the pin 54 resulted in a spot weld having the highest degree of strength as compared to spot welds made using other FSSW tool geometries.

FIG. 4D is an end-view showing the pin 54 and the toolholder 50.

It is one aspect of the present invention that the area be maximized that is being processed to create the FSSW joint. In other words, it is desirable to maximize the amount of material that is being stirred by the FSSW tool. One way to accomplish this objective is to use a large shoulder on the FSSW tool. Ideally, a tool having a shank with a cylindrical working end that might or might not have a pin would maximize the shoulder of the FSSW tool.

Some of the consequences of this tool geometry are that the FSSW tool would probably experience a large axial load, the FSSW tool would probably have to be plunged near or at the interface of the lap joint, and the FSSW tool could have undesirable material flow.

One method for overcoming these difficulties is to increase the size of the joining area. This is accomplished by translating the FSSW tool away from the plunge axis during the FSSW process.

The FSSW process may also include a dwell period in which the FSSW tool is not moved, or it may have no dwell period and the FSSW tool is kept moving.

It is another aspect of the invention that tool geometries that manage the flow of the material being bonded are preferred, and should include design criteria for the flow of the particular material type being FSSW.

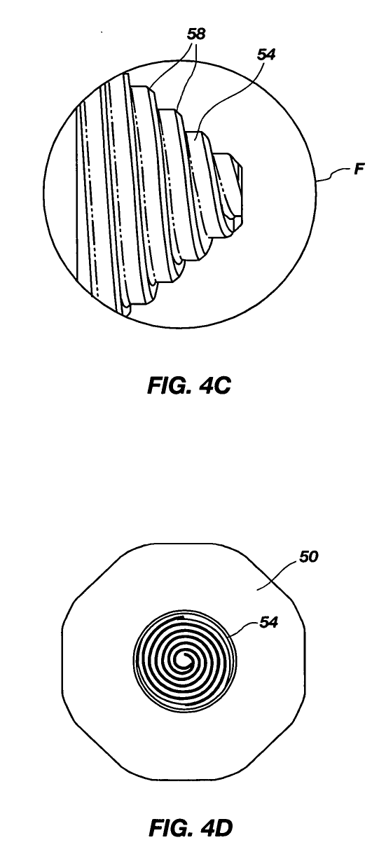

FIG. 5 is an illustration of an FSSW tool wherein FSSW parameters have been modified to obtain different spot welds. The first spot weld 60 was made using a cycle time of 2.1 second. The second spot weld 62 was made using a cycle time of 1.6 second.

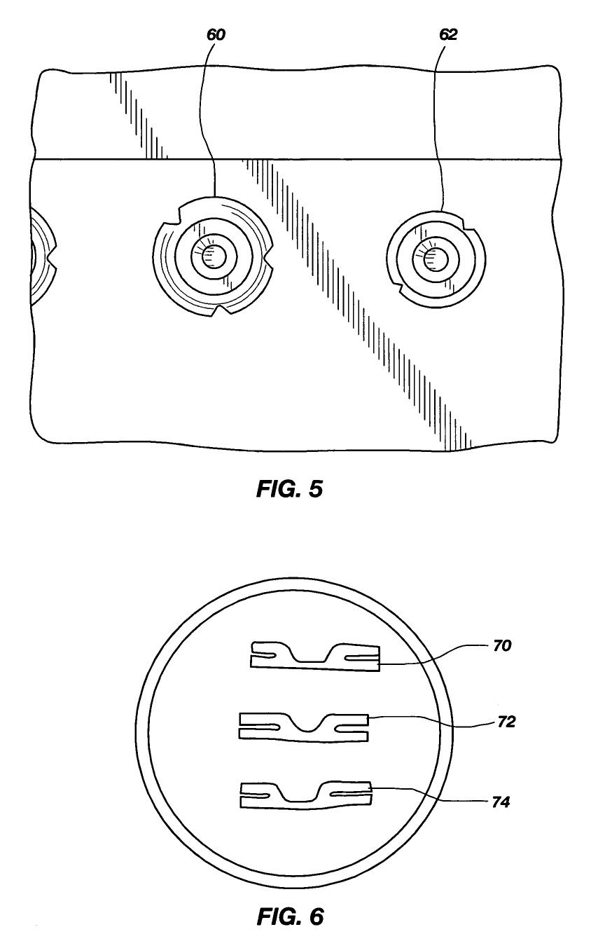

FIG. 6 is provided as photomicrographs of spot welds using a FSSW tool that has been performed on DP600, and which shows three different cross sections that were created as a result of changing parameters of the FSSW process. Weld 1 (70) had a FSSW cycle time of 2.5 seconds, had a 50 mm/min plunge, and a 213 mm/min extract. Weld 2 (72) had a FSSW cycle time of 1 second, had a 213 mm/min plunge, and a 213 mm/min extract. Weld 3 (74) had a FSSW cycle time of 1.5 seconds, had a 213 mm/min plunge, included a dwell time of 0.5 seconds, and had a 213 mm/min extract.

It is noted that Weld 2 (72) shows that the two materials being joined were not flush, and thus have a gap between them after the spot weld is performed.

Other aspects of the invention include the use of disposing asymmetric features on the pin and shoulder, using a retractable pin, having a pin with varying degrees of taper radii, parabolic, non-linear geometries, having threads on the pin, having threads on the shoulder, having flats and/or threads on the pin, and moving the FSSW tool so that the FSSW tool is moved in any direction away from the plunge axis to increase the area under the tool.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for performing friction stir spot welding of two workpieces comprised of high melting temperature materials using a friction stir spot welding (FSSW) tool, said method comprising the steps of:
(1) providing a friction stir spot welding (FSSW) tool having a shoulder and a pin, wherein the shoulder and the pin have a superabrasive coating disposed thereon, and wherein the superabrasive coating has a higher melting temperature than the two workpieces; and
(2) friction stir spot welding the two workpieces together by plunging the FSSW tool into the two workpieces and withdrawing the FSSW tool without moving the FSSW tool transversely relative to a plunge axis.

2. The method as defined in claim 1 wherein the method further comprises the step of moving the FSSW tool transversely relative to the plunge axis before withdrawing the FSSW tool from the two workpieces.

3. The method as defined in claim 1 wherein the method further comprises the step of increasing a pin length to shoulder width ratio relative to friction stir welding tools to thereby maximize mixing of the two workpieces together.

4. The method as defined in claim 1 wherein the method further comprises the step of including a dwell time wherein the FSSW tool remains plunged into the two workpieces and is rotating but no translational movement is performed.

5. The method as defined in claim 1 wherein the method further comprises the step of modifying the pin to include a stepped spiral thread to thereby maximize mixing of the material of the two workpieces.

6. The method as defined in claim 1 wherein the method further comprises the step of modifying FSSW parameters to thereby modify a resulting spot weld, wherein the FSSW parameters are selected from the group of FSSW parameters comprised of dwell time, plunge depth, cycle time, and translational movement of the FSSW tool relative to a plunge axis.

7. The method as defined in claim 1 wherein the method further comprises the step of modifying the FSSW tool to thereby modify a resulting spot weld, wherein the modifications to the FSSW tool are selected from the group of modifications comprised of taper of the pin, cross-sectional geometry of the pin, the presence of threads on the pin, the presence of threads on the shoulder, and the presence of flats on the pin.

8. A method for performing friction stir spot welding of two workpieces comprised of high melting temperature materials using a friction stir spot welding (FSSW) tool, said method comprising the steps of:
(1) providing a friction stir spot welding (FSSW) tool having a pin, wherein the pin has a superabrasive coating disposed thereon, and wherein the superabrasive coating has a higher melting temperature than the two workpieces; and
(2) friction stir spot welding the two workpieces together by plunging the FSSW tool into the two workpieces and withdrawing the FSSW tool without moving the FSSW tool transversely relative to a plunge axis.

9. The method as defined in claim 8 wherein the method further comprises the step of moving the FSSW tool transversely relative to the plunge axis before withdrawing the FSSW tool from the two workpieces.

10. The method as defined in claim 8 wherein the method further comprises the step of including a dwell time wherein the FSSW tool remains plunged into the two workpieces and is rotating but no translational movement is performed.

11. The method as defined in claim 8 wherein the method further comprises the step of modifying the pin to include a stepped spiral thread to thereby maximize mixing of the material of the two workpieces.

12. The method as defined in claim 8 wherein the method further comprises the step of modifying FSSW parameters to thereby modify a resulting spot weld, wherein the FSSW parameters are selected from the group of FSSW parameters comprised of dwell time, plunge depth, cycle time, and translational movement of the FSSW tool relative to a plunge axis.

13. The method as defined in claim 8 wherein the method further comprises the step of modifying the FSSW tool to thereby modify a resulting spot weld, wherein the modifications to the FSSW tool are selected from the group of modifications comprised of taper of the pin, cross-sectional geometry of the pin, the presence of threads on the pin, and the presence of flats on the pin.

14. A friction stir spot welding (FSSW) tool for performing spot welds of two workpieces comprised of high melting temperature materials, said FSSW tool comprised of:
a shoulder having a superabrasive coating disposed thereon;
a pin coupled to the shoulder and having a superabrasive coating disposed thereon, wherein the superabrasive coating has a higher melting temperature than the two workpieces; and
wherein a pin length to shoulder width ratio is adjusted to thereby maximize mixing of the materials of the two workpieces.

15. The FSSW tool as defined in claim 14 wherein the pin is further comprised of a stepped spiral thread to thereby maximize mixing of the materials of the two workpieces.

16. A friction stir spot welding (FSSW) tool for performing spot welds of two workpieces comprised of high melting temperature materials, said FSSW tool comprised of:
a shank;
a pin coupled to the shank and having a superabrasive coating disposed thereon, wherein the superabrasive coating has a higher melting temperature than the two workpieces; and
wherein a pin length to shoulder width ratio is adjusted to thereby maximize mixing of the materials of the two workpieces.

17. The FSSW tool as defined in claim 16 wherein the pin is further comprised of a stepped spiral thread to thereby maximize mixing of the materials of the two workpieces.
